(19) United States
(12) Patent Application Publication
(10) Pub. No.: US 2011/0161359 A1
(43) Pub. Date: Jun. 30, 2011

(54) METHOD AND APPARATUS FOR SEARCHING FOR SUBJECTIVE ANALYSIS ACCORDING TO MENTAL STATUS

(76) Inventor: Aidan Joungil CHO, Austin, TX (US)

(21) Appl. No.: 12/983,435

(22) Filed: Jan. 3, 2011

(30) Foreign Application Priority Data
Dec. 31, 2009 (KR) 10-2009-136202

(51) Int. Cl. G06F 17/30

(52) U.S. Cl. 707/769; 707/E17.014

(57) ABSTRACT

A method and system for writing and searching for subjective definitions, opinions, and feelings about a predetermined issue such as a word and a phrase. The method includes receiving from a first user who access a server system a selection about a predetermined issue, receiving a selection about at least one layer from among a plurality of layers that are generated with regard to the predetermined issue, and receiving a subjective analysis about the predetermined issue that belongs to the selected layer, wherein the selections and subjective analysis are performed by the server system; storing in the server system the subjective analysis with regard to the issue according to a layer; storing information for determining whether second users accessing the server system have an access right to a layer assigned by the first user; searching the analysis storage unit accessing the server system so as to determine whether the subjective analysis about an issue requested by the second user is stored in the analysis storage unit; and outputting a subjective analysis that belongs to a layer to which is allowed to be accessed by the access information determination unit from among searched subjective analyses, wherein the plurality of layers are divided according to information including an access right to the subjective analysis.

### CROSS-REFERENCE TO RELATED PATENT APPLICATION

This application claims the benefit of Korean Patent Application No. 10-2009-0136202, filed on Dec. 31, 2009, in the Korean Intellectual Property Office, the disclosure of which is incorporated herein in its entirety by reference.

### BACKGROUND OF THE INVENTION

1. Field of the Invention

One or more aspects of the present invention relate to methods and systems for writing and searching for subjective definitions, opinions, and feelings about a predetermined issue such as a word or a phrase, and more particularly, to methods and systems for writing and searching for subjective definitions, opinions, and feelings about a predetermined issue in an Internet website, dividing the subjective definitions, opinions, and feelings according to a layer, and allowing users having an access right to a layer to read a subject analysis in the layer.

2. Description of the Related Art

The meaning of words or phrases in daily use may be expressed in two ways.

One of them is the dictionary meaning, that is, the meaning obtained by analysis based on realistic and objective information, and the other one is the meaning obtained by subjective or emotional analysis based on personal experiences.

The subjective and emotional analysis represents a mental aspect of a provider of the subjective and emotional analysis. A degree by which mental and ideological aspects are represented may be determined according to a word or phrase that is a subject of the analysis.

Recently, services for providing personal spaces via wired and wireless communication networks, such as blogs, twitters, and the like have been widely used.

An individual user writes subjective and emotional writing about a personal daily life or personal interest on such a website. The subjective and emotional writing is disclosed to users who visit a blog.

Users who visit a personal space of an individual user on a website such as a blog or the like may notice personal mental and ideological states by reading the writing on the blog or the like.

However, only a personal thought of a user managing a personal space such as a blog or the like may be noticed on the personal space. Thus, in order to know many people's thoughts, users need to search for personal writings on the personal space such as a blog, and thus, it is complicated to check many people's thoughts.

### SUMMARY OF THE INVENTION

One or more aspects of the present invention provide methods and systems for obtaining subjective thoughts of a subscriber about a predetermined issue (a word, a phrase, or the like) through a single website.

One or more aspects of the present invention provide a computer readable recording medium having recorded thereon a program for executing the method.

According to an aspect of the present invention, there is provided a method of searching for a subjective analysis according to a mental status, the method including receiving from a first user who access a server system a selection about a predetermined issue, receiving a selection about at least one layer from among a plurality of layers that are generated with regard to the predetermined issue, and receiving a subjective analysis about the predetermined issue that belongs to the selected layer, wherein the selections and subjective analysis are performed by the server system; storing the subjective analysis with regard to the issue according to a layer; storing in the server system information for determining whether second users accessing the server system have an access right to a layer assigned by the first user; searching the analysis storage unit accessing the server system so as to determine whether the subjective analysis about an issue requested by the second user is stored in the analysis storage unit; and outputting a subjective analysis that belongs to a layer to which is allowed to be accessed by the access information determination unit from among searched subjective analyses, wherein the plurality of layers are divided according to information including an access right to the subjective analysis.

According to another aspect of the present invention, there is provided a system for searching for a subjective analysis according to a mental status, the system including an input unit for receiving from a first user a selection about a predetermined issue, for receiving a selection about at least one layer from among a plurality of layers that are generated with regard to the predetermined issue, and for receiving a subjective analysis about the predetermined issue that belongs to the selected layer; an analysis storage unit including a region for storing information about the selected layer with regard to the selected issue, and a region for storing the subjective analysis, for storing data according to information selected by the first user, and for storing the subjective analysis with regard to the issue according to a layer; an access information determination unit for storing information for determining whether second users have an access right to a layer assigned by the first user, and for determining whether the second users have an access right to a layer; and an output unit for searching the analysis storage unit so as to determine whether the subjective analysis about an issue requested by the second user is stored in the analysis storage unit, and for outputting a subjective analysis that belongs to a layer to which is allowed to be accessed by the access information determination unit from among searched subjective analyses, wherein the plurality of layers are divided according to information including an access right to the subjective analysis.

When the first user inputs a plurality of subjective analyses about a single issue to the same layer, the analysis storage unit stores the plurality of subjective analyses together with information about times when the plurality of subjective analyses are input, but does not delete or correct a subject analysis that is first input. A plurality of subjective analyses about a single issue may be input to different layers, and the layer of the subject analysis that is already stored may be copied or moved to another layer.

The input unit may provide issues with high frequency to the first user from among issues stored in the analysis storage unit.

A page output by the output unit may be set so as not to copy the subjective analysis and to provide address information for accessing the subjective analysis, and when a third user requests an access to the subjective analysis by using the address information, if the access information determination unit determines that the third user has an access right to the subjective analysis, the page may provide the subjective analysis to the third user.

According to another aspect of the present invention, there is provided a computer readable recording medium having recorded thereon a program for executing the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system for searching a subjective analysis according to a mental status, according to an embodiment of the present invention;

FIG. 2 is a flowchart of a method of searching for a subjective analysis according to a mental status, according to an embodiment of the present invention;

FIG. 3 shows a screen corresponding to the user's selection on a website, according to an embodiment of the present invention;

FIG. 4 shows a screen including a window for inputting an issue selected by a user, according to an embodiment of the present invention;

FIG. 5 is a diagram for explaining a layer, according to an embodiment of the present invention;

FIG. 6 is a flowchart of a method of outputting a search result through an output unit when a user requests search for a predetermined issue, according to an embodiment of the present invention; and

FIG. 7 is a flowchart of a method of searching for a subjective analysis according to a mental status when a user(writer) invites a user to read a subject analysis written by the user(writer), according to another embodiment of the present invention.

### DETAILED DESCRIPTION OF THE INVENTION

The present invention is characterized in that a subscriber accessing a website determines layers of a subjective and emotional analysis about words and phrases related to various issues, and writes a subjective and emotional analysis according to the determined layers, and only connectors having an access right to the determined layer are allowed to read the subject analysis.

The connectors may be allowed to read all the subject analyses which are assigned to a layer allowed to be searched for about a predetermined word/phrase on a single website and corresponding to a layer allowed to be searched for, and thus the connectors may be allowed to read many people's subject analyses, opinions, or the like about a predetermined issue, that is, many people's thoughts about a single word/phrase or the like.

The present invention will now be described more fully with reference to the accompanying drawings, in which exemplary embodiments of the invention are shown.

FIG. 1 is a block diagram of a system for searching for a subjective analysis according to a mental status, according to an embodiment of the present invention. The system according to the present embodiment is included in a server system for providing services via the Internet, or the like, and includes an input unit 110, an analysis storage unit 120, an output unit 130, and an access information determining unit 140.

The input unit 110 receives a user's selection about an issue that is a subject of a subjective analysis of the user from the user, and also receives the subjective analysis, a layer to which the subjective analysis is assigned, and other related issues from the user.

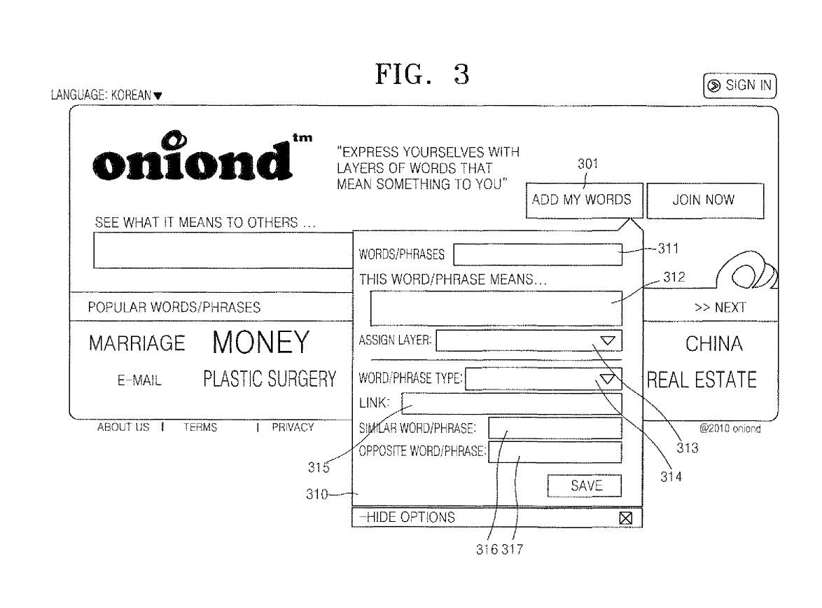

FIG. 3 shows a screen corresponding to the user's selection on a website, according to an embodiment of the present invention.

As illustrated in FIG. 3, a pop-up window 310 that pops up when a ‘ADD MY WORD’ button 301 is clicked on a screen of the website may include a word/phrase input box 311 for inputting a word/phase corresponding to an issue to be selected, a word/phrase analysis input box 312 for inputting analysis about the selected word/phrase, a box 313 for determining a layer to which the analysis is to be assigned, a box 314 for inputting a type of the word/phrase, a link input box 315 for linking with another website with regard to the selected issue, a word/phrase input box 316 for inputting a word/phrase similar to the selected issue, and a word/phrase input box 317 for inputting a word/phrase opposite to the selected issue.

The issue that is selected by the user in order to perform the subjective analysis may be input in the form of a word or phrase, as shown in FIG. 3.

The user may select a word/phrase that is a subject of the subjective analysis by directly inputting the word/phrase, or alternatively, by selecting the word/phrase from a list that is previously set by a system operator.

Although not illustrated in FIG. 3, a word/phrase may be selected together with a category to which the word/phrase belongs. The category may also be selected by directly inputting the category, or alternatively, by selecting the category from a list that is previously set by a system operator.

When the user inputs or searches for a word/phrase about a predetermined issue through the input unit 110, the input unit 110 may also be used to output words/phrases that are selected many times or words/phrases that are searched for many times on the screen, thereby facilitating a user's selection, or motivating the user to participate in making subjective subject analyses about the words/phrases that are selected many times.

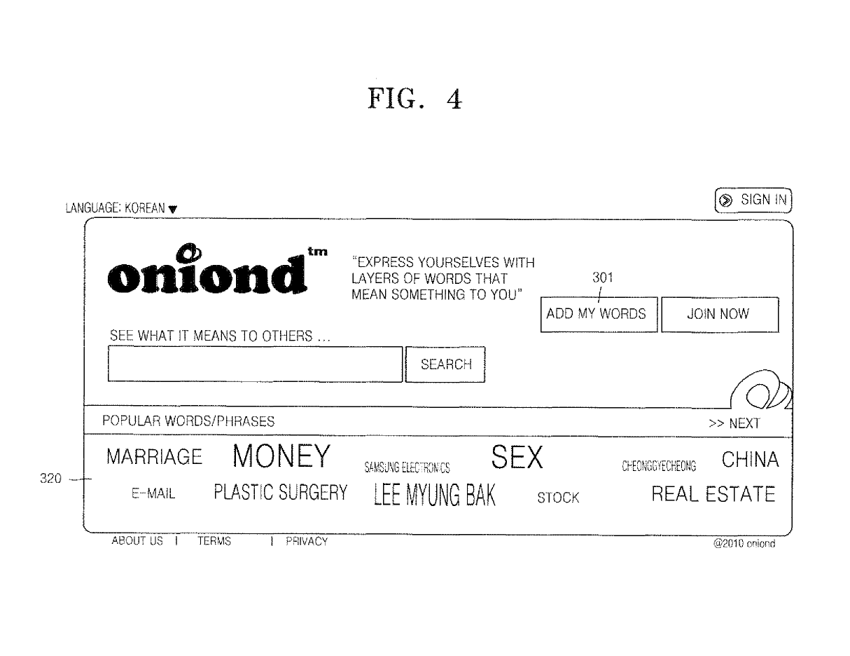

FIG. 4 shows a screen including a window for inputting or searching for an issue selected by a user, according to an embodiment of the present invention. As shown in FIG. 4, popular words/phrases are written on a bottom portion 320 of the screen, and thus, a user may refer to the popular words/phrases when the user inputs or searches for issues.

The word/phrase input box 311, the word/phrase subject analysis input box 312, and the box 313 for determining a layer to which the subject analysis is to be assigned are important from among various input boxes illustrated in FIG. 3.

Throughout this specification, a layer is a range determined according to a condition when other users other than a user(writer) writing a subject analysis of a subjective analysis are allowed to read the subject analysis, that is, the other users have access rights to the subjective analysis. The user(writer) may select at least one of a plurality of layers, and may input his or her subject analysis.

Throughout this specification, when the user(writer) selects one issue, a plurality of layers are generated with regard to the selected issue. The user(writer) may select at least one layer from among the generated layers, and may input his or her thought about the selected issue.

The layer may be determined according to a predetermined standard. The standard may not be fixed. However, according to a disclosure range, examples of the layers may include a layer in which all connectors are allowed to read a subject analysis, a layer in which only a subscriber joining and logging in a website operating according to an embodiment of the present invention is allowed to read a subject analysis, a layer in which only a subscriber setting a user(writer) of a subject analysis as an interested user are allowed to read the subject analysis, a layer in which a user(writer) of a subject analysis and a subscriber who determine respective counterparts as interested users are allowed to read the subject analysis, a layer in which only a user who is determined by a user(writer) of a subject analysis is allowed to read the subject analysis, and a layer in which only a user(writer) of a subject analysis is allowed to read the subject analysis.

The layers may be further divided according to whether to write a comment, whether to transmit the user(writer)'s own subject analysis to another user, whether to be invited to be allowed to read the user(writer)'s own writing, or the like.

A standard for dividing the layers may be previously determined by a system operator, or alternatively may be divided according to a condition determined by a user.

In addition, a basic condition may be determined by the system operator, and a detailed condition may be determined by the user.

For example, a condition determined by the system operator is set according to a disclosure range. Thus, when a user(writer) writes a subjective analysis and selects any one from among set disclosure ranges, the written subject analysis is assigned to a corresponding layer. Subject analyses which belong to a same layer may be divided into more detailed layer based on whether the user has the right to write a comment. That is, the user(writer) may give different right to write a comment on the subject analysis to each user, respectively.

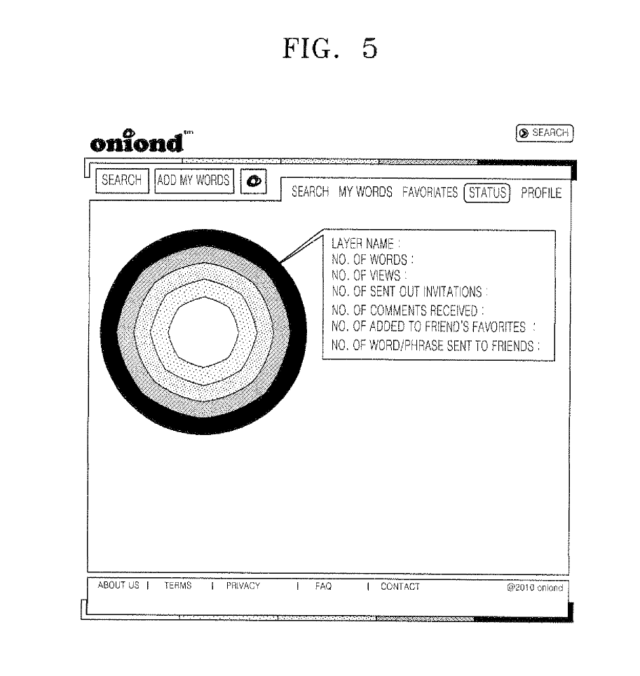

The divided layers may have a form as illustrated in FIG. 5. A user(writer) may upload a subject analysis of subjective analysis that is allowed to be read by users that are rarely related to the user(writer) of the subject analysis to an outermost layer. In addition, the closer to an innermost layer, the closer the relationship between the user(writer) of the subject analysis and users who are allowed to read the subject analysis.

For example, with regard to the term ‘marriage’, although the user(writer) may tell people whom he or she does not know very well in a positive way, the user(writer) may tell a close friend or acquaintance whom he or she knows very well in a negative way.

In this case, with regard to the term ‘marriage’, the user(writer) may upload a subject analysis of a positive analysis to the outermost layer, that is, to a layer disclosed to the public, and may upload a subject analysis of a negative analysis to an innermost layer.

The user(writer) may invite a predetermined user to read the user(writer)'s own subject analysis through the input unit 110. In this case, the user(writer) may invite the predetermined user by transmitting the user(writer)'s own subject analysis to the predetermined user or determining that only the predetermined user is allowed to read the user(writer)'s own subject analysis and notifying the predetermined user about the user(writer)'s own subject analysis itself or the determination.

In this case, invitation information may be transmitted to the invited user by e-mail. When the invited user accesses a website operating according to an embodiment of the present invention, the invitation information may be indicated on the website, or invitation text may be output through a screen.

When the user(writer) writes a subject analysis about an issue selected by the user(writer) through the input unit 110, the user(writer) may write the subject analysis in a simple text type, may add much multimedia information such as image and a moving picture that are required for the subject analysis, or alternatively, may add link information so as to access related websites.

The analysis storage unit 120 stores the subject analysis of the subjective analysis which is written through the input unit 110.

The analysis storage unit 120 includes a region for storing an issue selected by a user(writer), a region for storing the user(writer)'s subject analysis about the issue selected by the user(writer), a region for storing information about a layer of the subject analysis input by the user(writer), a region for storing a point of time when the user(writer) inputs the subject analysis, and the like, and stores data about the regions.

The information about a layer is basically and previously set by a system operator as level information, or level information that is previously set by a user(writer). When the user(writer) inputs a subject analysis and then sets a layer level of the subject analysis, a data bit of the region for storing the information about layer is changed to a layer level desired by the user(writer).

In addition, when the subject analysis is stored in the analysis storage unit 120, the subject analysis may be stored in a type that may be extracted according to a user, an issue, a layer, or a time.

The layer of the subject analysis that is already stored may be copied or moved to another layer. In this case, a data bit of the region for storing the layer information of the analysis storage unit 120 may be changed internally.

When the user(writer) assigns two different analyses about a single issue selected by the user(writer) to the same layer, the analysis storage unit 120 may store the two different analyses, but not delete or correct the first analysis.

In this case, times when subject analyses are input may be known by storing time information together with the subject analyses.

In this case, since a change in a subject analysis about a single issue according to a time may be known, a change in the user(writer)'s thought may be known. Thus, as time elapses or as the user(writer) gets old, a change in the user(writer)'s thought may be known.

The access information determining unit 140 stores information about whether a user has an access right to another user's layer from among a plurality of layers, and determines whether the user accesses a subject analysis of each layer.

For example, layers of a user(writer) A include three layers such as a first layer, a second layer, and a third layer. In this case, when the user A assigns a right of reading from the second layer to the first layer to users B and C, assigns a right of reading from the first layer to the third layer to a user D, and assigns a right of reading the third layer to all users, information about these facts is stored. Then, when other users want to read a subject analysis of the user A, it may be determined whether the users have an access right to a layer to which the subject analysis belongs.

The user(writer) may determine an access right to each layer, or may indirectly determine the access right based on a condition. Thus, the access information determining unit 140 determines whether to access a subjective analysis, which belongs to each layer, according to the condition.

For example, when a user sets the user A as an interested user, if the user is allowed to read a subject analysis belonging to the second layer of the user A, the access information determining unit 140 stores a list of users that are set as interested users by each user, and determines whether other users may access subject analyses that belong to the second layer of the user A, based on the list.

The output unit 130 outputs information stored in the analysis storage unit 120 through the website.

As a basic type, when a user searches for a predetermined issue, analyses about the predetermined issue may be extracted and output on a screen.

When connectors request search for a predetermined issue, the output unit 130 extracts issues corresponding to the predetermined issue, and analyses about the issues, from among the information stored in the analysis storage unit 120. Then, the output unit 130 extracts subject analyses that belong to a layer that is allowed to be accessed, and output the subject analyses on the screen.

An issue may be searched for according to a simple word/phrase or a user(writer) of a subjective analysis. Alternatively, an issue may be searched for by inputting a plurality of conditions.

When an issue is searched for by using a word or the like, the word included in a subjective analysis may be a search subject. However, as the main objective of the present invention is to know people's thoughts about the issue, the search subject may be an issue selected by users.

Throughout this search, a user may know various people's thoughts about a predetermined issue at one time. Specifically, when a user(writer) who is close to a user and allows the user to read a subject analysis about the issue writes the subject analysis, the user may know his or her deep thought.

As another example, when a registered user accesses and logs in a website, a subject analysis written by a user(writer) who invites the registered user, or invitation information may be output on a private page (which is generally assigned in a type of ‘my page’) that is assigned to each user.

In this case, simple invitation information or link information for accessing the subject analysis may be output, or alternatively, the subject analysis itself may be output.

In addition, a user may transmit the subject analysis that the user is allowed to access, to another user.

In this case, if the user transmits the subject analysis by a system that is not under control of a system operating according to an embodiment of the present invention, the subject analysis of a user(writer) may be exposed to an unspecific user regardless of an access right to a layer, which is given by the user(writer). Thus, in order to overcome this problem, when the subject analysis is exposed to an external system, only address information (link information) may be transmitted.

That is, the output unit 130 may set a page where the subject analysis is output so that the subject analysis may not be copied from a website.

Since only the address information is transmitted, when the unspecific user tries to access the subject analysis by using the address information, if an access right to the subject analysis is restrictive, the output unit 130 may be controlled so that the unspecific user may log in the website and the subject analysis may be output only to a user having an access right to the subject analysis, prior to outputting the subject analysis.

In other words, the output unit 130 sets the webpage so that the subject analysis of the user(writer) may not be copied when the subject analysis is output. In addition, when there is a request for access to the subject analysis, if an access right to the subject analysis is restrictive, the output unit 130 sets the webpage so that a page containing the subject analysis may be output only to a user having an access right to the subject analysis, which is approved by the access information determining unit 140.

In this case, the subject analysis may be exposed only to users who are allowed to read the subject analysis by the user(writer).

When the subject analysis is transmitted in a system according to an embodiment of the present invention, that is, when the subject analysis is transmitted to a subscriber of the system, the output unit 130 may check whether the subscriber has an access right to the subject analysis, and then may transmit the subject analysis.

In this case, that the subject analysis is transmitted to a user in the system means that an invitation message including link information about the subject analysis is output when the user receiving the subject analysis logs in a website so as to allow the user to access the subject analysis, or that the subject analysis is output on a private page of the user.

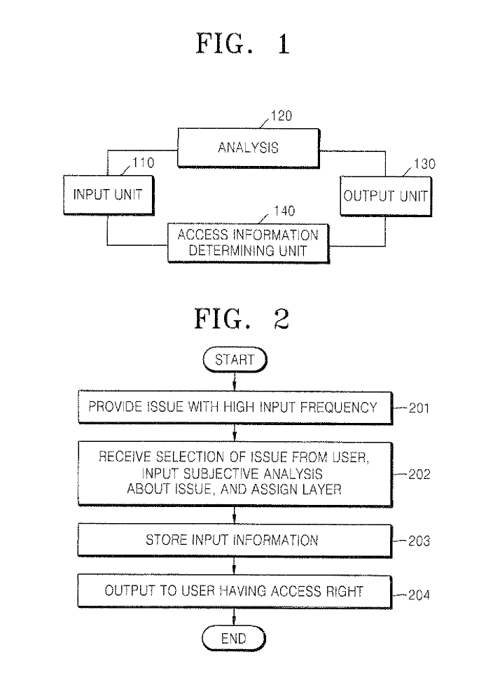

A method of searching for a subjective analysis according to an embodiment of the present invention will be described in detail. FIG. 2 is a flowchart of a method of searching for a subjective analysis according to a mental status, according to an embodiment of the present invention.

When a subscriber of a system according to an embodiment of the present invention accesses a website operating according to an embodiment of the present invention, an image of FIG. 4 is output on a screen.

As illustrated in FIG. 4, the input unit 110 extracts words/phrases that are selected many times based on a frequency, and outputs the words/phrases on a website (operation 201).

Thus, a user may know the words/phrases that are selected many times so as to refer to the words/phrases when selecting an issue as a subject of subjective analysis, which allows the user to participate in the subjective analysis about the issue, thereby increasing the popularity of the website.

When the user performs a subjective analysis on a predetermined issue, the user writes a subject analysis in the pop-up window 310 that pops up by clicking on the ‘ADD MY WORD’ button 301, as shown in FIG. 5.

The input unit 110 may receive information written by a user, in particular, a user's selection about an issue as a subject of a subjective analysis, a subject analysis about the selected issue, a layer to which the subject analysis belongs, and additional information determined according to a system operator or the user (operation 202).

The selected issue as a subject of a subjective analysis may be input as a word or phrase as shown in FIG. 3. As described above, the user may select the word or the phrase by directly inputting the word/phrase, or alternatively, by selecting the word or the phrase from a list that is previously set by a system operator.

When the selected issue is input, a category of the word/phrase, similar words/phrases, opposite words/phrases, types of words/phrases, or the like may be further input, as described above.

As described above, throughout this specification, a layer is a range determined according to a condition in that other users other than a user(writer) writing a subjective analysis is allowed to read the subject analysis, that is, the user has an access right to the subjective analysis, or according to whether to write a subject analysis. A standard for dividing the layers may be previously determined by a system operator, or alternatively may be divided according to a condition determined by a user. In addition, a basic condition may be determined by the system operator, and a detailed condition may be determined by the user.

Thus, a user(writer) may expose a deep thought only to a user who is identified as a close friend or acquaintance online by writing different subject analyses in layers.

The analysis storage unit 120 stores the subject analysis in a type that may be extracted according to a user, a word/phrase, a layer, or a time (operation 203).

The analysis storage unit 120 includes a region for storing an issue selected by a user(writer), a region for storing the user(writer)'s subject analysis about the issue selected by the user(writer), a region for storing information about a layer of the subject analysis input by the user(writer), a region for storing a time when the user(writer) inputs the subject analysis, and the like, and for storing data about the regions. When a user(writer) sets a layer, a data bit of the region for storing the information about layer is changed to a layer level desired by the user(writer), and the layer level desired by the user(writer) is output, as described above.

In this case, when there is a subject analysis that is already written about the same issue selected by the user(writer), the analysis storage unit 120 stores times when subject analyses are input so that a change in the user(writer)'s thought about the same issue may be known, as described above.

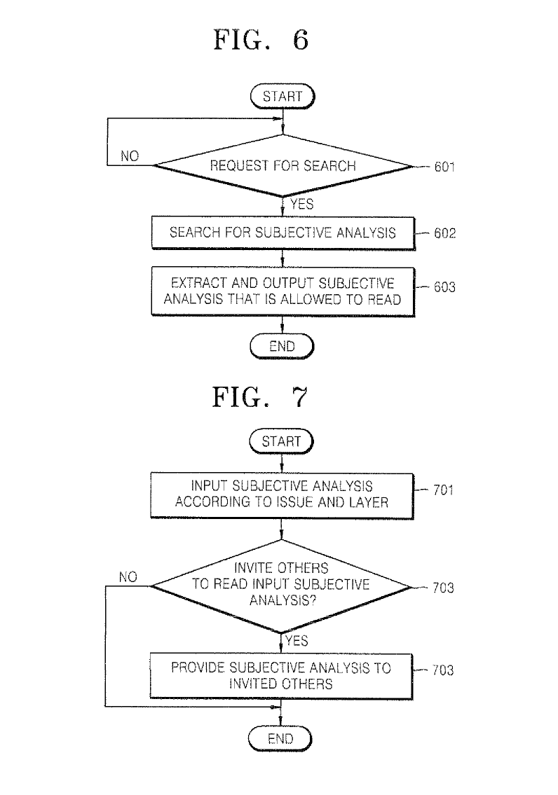

The output unit 130 outputs only a subject analysis that is allowed to be read, which is approved by the access information determining unit 140 user from among subject analyses stored in the analysis storage unit 120, when the user accesses a website (operation 204). This will be described in detail with referenced to FIGS. 6 and 7.

FIG. 6 is a flowchart of a method of outputting a search result through the output unit 130 when a user requests search for a predetermined issue, according to an embodiment of the present invention.

When the user requests searches for an issue by inputting the issue (operation 601), the output unit 130 searches for analyses about the issue input to the analysis storage unit 120 (operation 602), extracts a subject analysis that belong to a layer that is allowed to be accessed, which is approved by the access information determining unit 140, and outputs the subject analysis on a webpage to be read by the user (operation 603).

The order of the extracting of a subjective analysis by using words/phrase, and the extracting of a subjective analysis that is allowed to be accessed may be changed.

In this case, the output subject analysis may not be copied, and only address information (link information) may be disclosed. In order for a user to access the subject analysis by using the address information, the user needs to have an access right to the subject analysis. When an access right to the subject analysis is restrictive, the output unit 130 checks whether the user has an access right to the subject analysis, and then allows the user to access the subject analysis, as described above.

FIG. 7 is a flowchart of a method of searching for a subjective analysis according to a mental status when a user(writer) invites a user to read a subject analysis written by the user(writer), according to another embodiment of the present invention.

When the subject analysis written by the user(writer) is input and stored in operations 201 through 203) of FIG. 5 (operation 701), the output unit 130 checks whether the user(writer) invites the user to read the subject analysis (operation 702).

If the user(writer) invites the user to read the subject analysis, the output unit 130 may output invitation information and address information (link information) for accessing the subject analysis so that the user may access the subject analysis when the user accesses a website, or may output the subject analysis on a private page when the user logs in the website (operation 703).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

According to one or more embodiments of the present invention, many people's thoughts about a predetermined issue may be simultaneously known in a single website.

Moreover, since a user(writer) of a subject analysis allows a close friend or acquaintance to read the subject analysis so as to know deep thoughts, online relationships may be deepened.

In addition, a change in a thought about a predetermined issue may be known as time elapses, thereby providing a record for showing a change in a thought.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system for searching for a subjective analysis according to a mental status, the system comprising:
an input unit for receiving from a first user a selection about a predetermined issue, for receiving a selection about at least one layer from among a plurality of layers that are generated with regard to the predetermined issue, and for receiving a subjective analysis about the predetermined issue that belongs to the selected layer;
an analysis storage unit comprising a region for storing information about the selected layer with regard to the selected issue, and a region for storing the subjective analysis, for storing data according to information selected by the first user, and for storing the subjective analysis with regard to the issue according to a layer;
an access information determination unit for storing information for determining whether second users have an access right to a layer assigned by the first user, and for determining whether the second users have an access right to a layer; and
an output unit for searching the analysis storage unit so as to determine whether the subjective analysis about an issue requested by the second user is stored in the analysis storage unit, and for outputting a subjective analysis that belongs to a layer to which is allowed to be accessed by the access information determination unit from among searched subjective analyses,
wherein the plurality of layers are divided according to information including an access right to the subjective analysis.

2. The system of claim 1, wherein, when the first user inputs a plurality of subjective analyses about a single issue to the same layer, the analysis storage unit stores the plurality of subjective analyses together with information about times when the plurality of subjective analyses are input, but does not delete or correct a subject analysis that is first input.

3. The system of claim 1, wherein the input unit provides issues with high frequency to the first user from among issues stored in the analysis storage unit.

4. The system of claim 1, wherein a page output by the output unit is set so as not to copy the subjective analysis and to provide address information for accessing the subjective analysis, and
wherein, when a third user requests an access to the subjective analysis by using the address information, if the access information determination unit determines that the third user has an access right to the subjective analysis, the page provides the subjective analysis to the third user.

5. A method of searching for a subjective analysis according to a mental status, the method comprising:
receiving from a first user who access a server system a selection about a predetermined issue, receiving a selection about at least one layer from among a plurality of layers that are generated with regard to the predetermined issue, and receiving a subjective analysis about the predetermined issue that belongs to the selected layer, wherein the selections and subjective analysis are performed by the server system;
storing the subjective analysis with regard to the issue according to a layer;
storing in the server system information for determining whether second users accessing the server system have an access right to a layer assigned by the first user;
searching the analysis storage unit accessing the server system so as to determine whether the subjective analysis about an issue requested by the second user is stored in the analysis storage unit; and
outputting a subjective analysis that belongs to a layer to which is allowed to be accessed by the access information determination unit from among searched subjective analyses,
wherein the plurality of layers are divided according to information including an access right to the subjective analysis.

6. The method of claim 5, wherein, when the first user inputs a plurality of subjective analyses about a single issue to the same layer, the storing of the subjective analysis comprises storing the plurality of subjective analyses together with information about times when the plurality of subjective analyses are input, but not deleting or correcting a subject analysis that is first input.

7. The method of claim 5, further comprising providing issues with high frequency to the first user from among stored issues.

8. The method of claim 5, wherein a page output in the outputting of the subjective analysis is set so as not to copy the subjective analysis and to provide address information for accessing the subjective analysis,
further comprising, when a third user requests an access to the subjective analysis by using the address information, if the access information determination unit determines that the third user has an access right to the subjective analysis, providing the subjective analysis to the third user.

9. A computer readable recording medium having recorded thereon a program for executing the method of claim 5.
